(19) United States
(12) Patent Application Publication
(10) Pub. No.: US 2015/0308276 A1
(43) Pub. Date: Oct. 29, 2015

(54) ROBUST TURBINE BLADES

(71) Applicant: GENERAL ELECTRIC COMPANY, Schenectady, NY (US)

(72) Inventors: Chad Daniel KLEINOW, Cincinnati, OH (US); Nirsene Anna LANGENBRUNNER, Cincinnati, OH (US); Matthew Mark WEAVER, Cincinnati, OH (US)

(21) Appl. No.: 14/650,579

(22) PCT Filed: Dec. 16, 2013
(86) PCT No.: PCT/US2013/075477

§ 371 Date: Jun. 9, 2015

Related U.S. Application Data
(60) Provisional application No. 61/738,118, filed on Dec. 17, 2012.

(51) Int. Cl. F01D 5/28; F01D 5/14

(52) U.S. Cl. CPC F01D 5/288; F01D 5/141; F01D 5/147; F01D 5/284; F05D 2220/30; F05D 2240/307

(57) ABSTRACT

Robust turbine blade designs that minimize damage to turbine blades during a tip rub event, guard against further tip recession, and improve the resiliency of turbine blades 24 are provided. This may be achieved through various blade tip 12 designs, such as a recessed tip 28 or a protruding tip 98. It may also be achieved by providing the blade tip, shroud, or both with an environmental barrier coating (EBC) 22 having an abradable or abrasive layer.

### CROSS-REFERENCE TO RELATED APPLICATIONS

This application claims priority under 35 U.S.C. §119(e) of U.S. Provisional Patent Application No. 61/738,118 filed Dec. 17, 2012, in the name of the present inventors and entitled, “Robust Turbine Blades”, this provisional application being incorporated herein by reference.

### BACKGROUND

The invention relates generally to turbines. More specifically, the invention relates to robust turbine blades that withstand rubbing between a blade tip and a shroud without compromising mechanical integrity or performance.

A turbine assembly typically generates rotating shaft power by expanding hot compressed gas produced by combustion of a fuel. Gas turbine buckets or blades generally have an airfoil shape designed to convert the thermal and kinetic energy of the flow path gases into mechanical rotation of the rotor.

Turbine performance and efficiency may be enhanced by reducing the space between the tip of the rotating blade and the stationary shroud to limit the flow of air over or around the top of the blade that would otherwise bypass the blade. For example, a blade may be configured so that its tip fits close to the shroud during engine operation.

Turbine blades may be made of a number of materials, including nickel-based superalloys and ceramic matrix composites (CMCs). CMCs are an attractive alternative to nickel-based superalloys for turbine applications because of their high temperature capability and light weight.

Generating and maintaining an efficient tip clearance is critical when designing CMC turbine blades. CMC's inherent low strain-to-failure and reduced damage tolerance when compared to metallic superalloys raise concerns regarding blade durability during a turbine blade tip rub event. CMC recession or volatilization of silica formation in a gas combustion environment may also present challenges when attempting to preserve tight tip clearances.

During a tip rub event, radial clearances reach an interference condition and the airfoil tip impacts static shroud hardware imparting a large tangential force into the blade. This force induces a substantial bending moment into the airfoil, and shank which could then over load the part and induce permanent structural damage. Due to uncertainties in engine build clearances and shroud clearance control systems, design robustness best practices require turbine blades to withstand rubbing between a blade tip and a shroud without compromising mechanical integrity or performance.

CMC blades that overcome the above challenges are desirable in the art.

### SUMMARY

The invention provides robust turbine blade designs that minimize damage to turbine blades during a tip rub event, guard against further tip recession, and improve the resiliency of turbine blades. This may be achieved through various blade tip designs, such as a recessed tip or a protruding tip. It may also be achieved by providing the blade tip, shroud, or both with an environmental barrier coating (EBC) having an abradable or abrasive layer.

According to an embodiment of the invention, a blade may include a tip having a recessed or protruding configuration.

According to an embodiment of the invention, the blade may he made of a CMC and include an EBC. The shroud may be made of CMC and include an EBC, or it may be made of a metal and include a thermal bather coating (TBC) or other similar ceramic coating. In various embodiments of the invention, the EBC for the blade tip, shroud, or both the blade tip and shroud may include an abradable or abrasive layer.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a view of a blade tip according to the invention.

FIG. 2 is a perspective view of a blade tip having a recessed configuration according to an embodiment of the invention.

FIG. 3 is a cross-sectional view of a blade tip according to an embodiment of the invention.

FIG. 4 is a cross-sectional view of a blade tip according to an embodiment of the invention.

FIG. 5 is a cross-sectional view of a blade tip according to an embodiment of the invention.

FIG. 6 is a cross-sectional view of a blade tip according to an embodiment of the invention.

FIG. 7 is a cross-sectional view of a blade tip according to an embodiment of the invention.

FIG. 8 is a cross-sectional view of a blade tip according to an embodiment of the invention.

FIG. 9 is a perspective view of a blade tip having a protruding configuration according to an embodiment of the invention.

FIG. 10 is a cross-sectional view of a blade tip according to an embodiment of the invention.

FIG. 11 is a cross-sectional view of a blade tip according to an embodiment of the invention.

FIG. 12 is a perspective view of a blade tip having a recessed configuration and a patterned abradable or abrasive layer according to an embodiment of the invention.

FIG. 13 is a perspective view of a blade tip having a protruding configuration and a patterned abradable or abrasive layer according to an embodiment of the invention.

Wherever possible, the same reference numbers will be used throughout the drawings to represent the same parts.

### DETAILED DESCRIPTION

The invention provides robust turbine blade designs that minimize damage to turbine blades during a tip rub event, guard against further tip recession, and improve the resiliency of turbine blades. This may he achieved through various blade tip designs, such as a recessed tip or a protruding tip. It may also be achieved by providing the blade tip, shroud, or both with an EBC having an abradable or abrasive layer.

The blade tip may be made of a CMC material and may include an EBC having an abradable or abrasive layer. Various tip geometries, including recessed and protruding tips, and abradable or abrasive coatings help reduce the contact load in the blade during a tip rub event and minimize the potential damage to other critical areas of the turbine blade by reducing the area of the tip that may rub against the shroud.

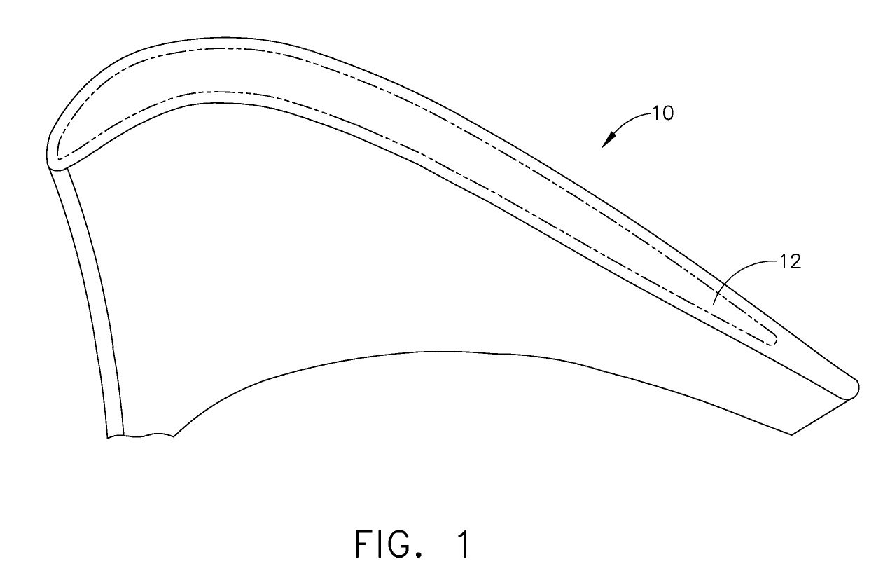

According to the invention, a blade having leading and trailing edges and a blade tip and opposed root end may further include, for example, a recessed tip or a protruding tip. FIG. 1 is a view of a blade tip 10 according to the invention. The blade tip 10 may have a recess or a protrusion 12.

When the blade tip has a recessed configuration, the sidewalls of the tip may form a depression in the tip. According to an embodiment of the invention, the depression may form an open channel along the length of the blade tip. The recess may have any radius or depth. For example, the recess may have a radius of about 0.018 inches to about 0.040 inches and a depth of about 0.040 inches to about 0.050 inches.

When the blade tip has a protruding configuration, the edge of the tip forms a raised portion towards the center of the tip in the through-thickness direction. According to another embodiment of the invention, the protrusion may form a ridge along the width of the blade tip. The protrusion may have any radius or depth. For example, the protrusion may have a radius of about 0.60 inches to about 0.80 inches and a depth of about 0.20 inches to about 0.60 inches.

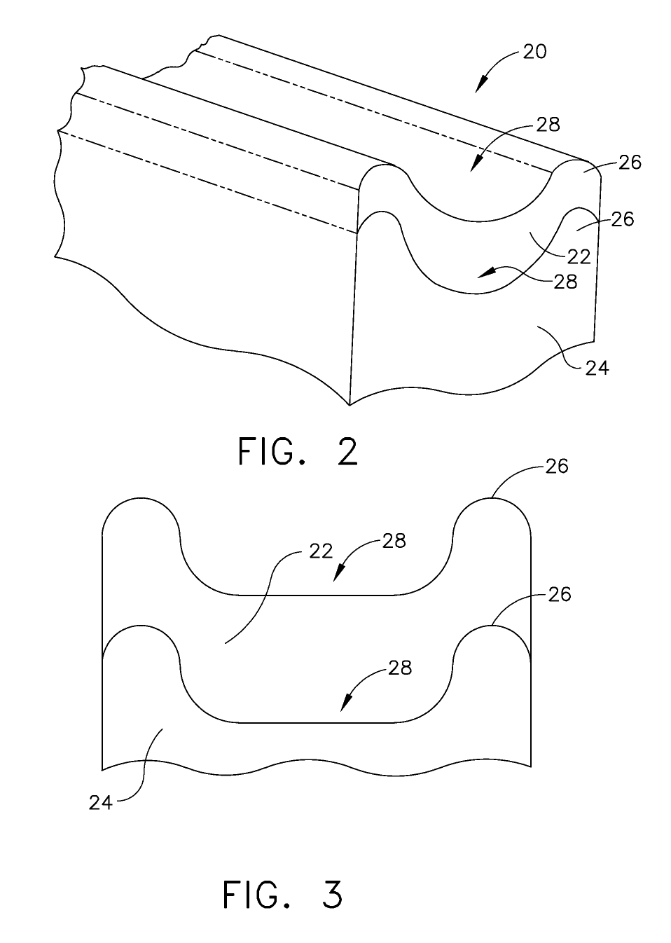

FIG. 2 is a perspective view of a blade tip having a recessed configuration according to an embodiment of the invention. The blade tip 20 includes an EBC 22, which may include an abradable or abrasive layer, and an underlying CMC substrate 24. As shown in FIG, 2, the edges 26 of the EBC 22 and CMC substrate 24 may have a curved shape and form a curved or rounded recess 28.

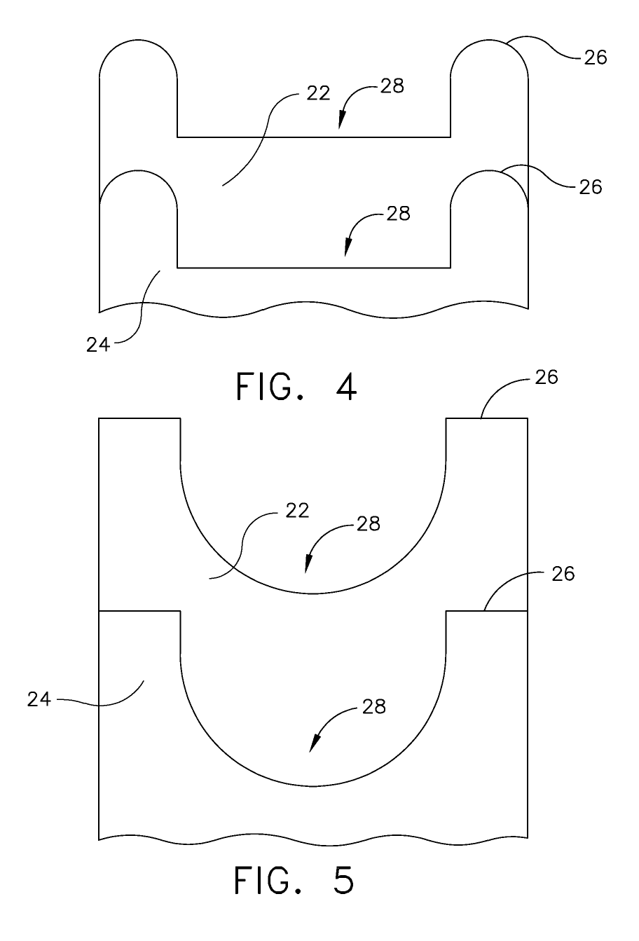

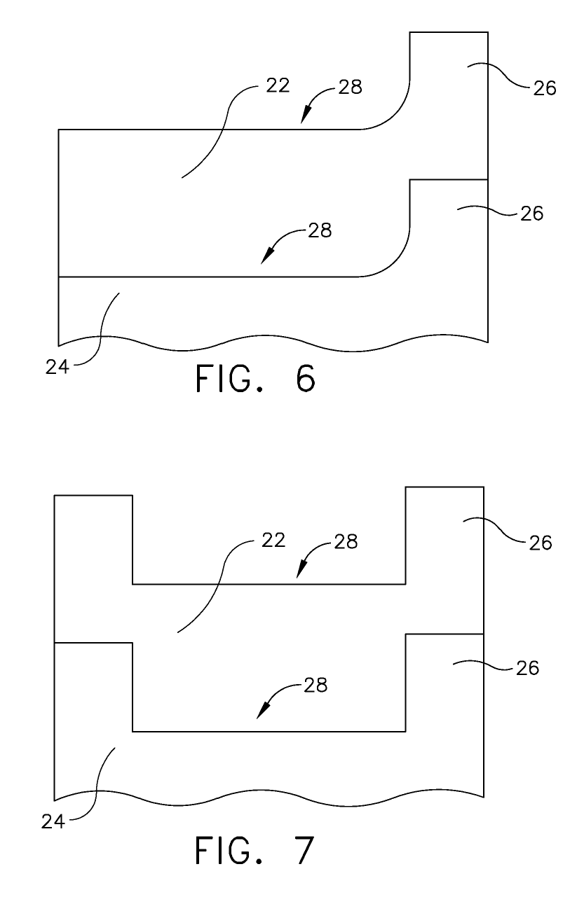

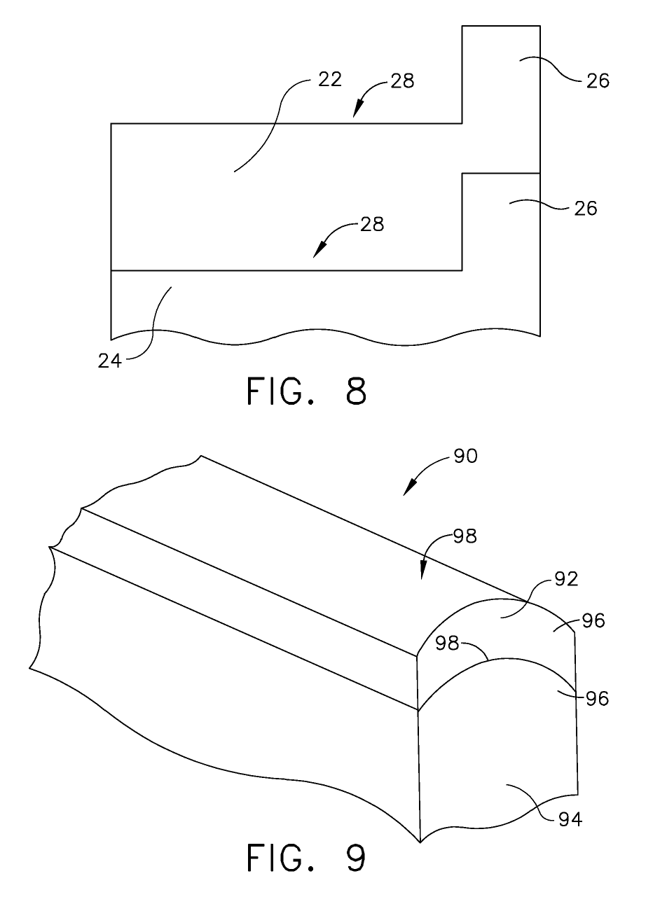

FIGS. 3-8 are cross-sectional views of blade tips having recessed tips according to various embodiments of the invention. As shown in FIG. 3, the edges 26 of the EBC 22 and CMC substrate 24 may have a curved shape and form a recess 28 with a flat base and curved or rounded edges. In addition, as shown in FIG. 4, the edges 26 of the EBC 22 and CMC substrate 24 may have a curved shape and form a recess 28 with a flat base and straight edges. According to another embodiment of the invention as shown in FIG. 5, the edges 26 of the EBC 22 and CMC substrate 24 may have a straight shape and form a curved or rounded recess 28. In another embodiment of the invention as shown in FIG. 6, the EBC 22 and CMC substrate 24 may have one edge 26 having a straight shape and form a recess 28 with a flat base and curved edges. In another embodiment of the invention as shown in FIG. 7, the edges 26 of the EBC 22 and CMC substrate 24 may have a straight shape and form a recess 28 with a flat base and straight edges. In another embodiment of the invention as shown in FIG. 8, the EBC 22 and CMC substrate 24 may have one edge 26 having a straight shape and form a recess 28 with a flat base and straight edges.

In addition to the EBC bond, the recessed configuration may form a mechanical hold to help retain abradable material and prevent full liberation of the coating during a rub event. In addition, the recess may defoim or partially fracture under high tip rub forces to reduce impact on the remaining highly loaded areas of the GMC blade. The protruding configuration may allow for a reduced area at the tip, which may result in reduced tip rub forces by producing less pressure on the blade and may allow better EBC chemical adhesion due to the larger radius.

FIG. 9 is a perspective view of a blade tip having a protruding configuration according to another embodiment of the invention. The blade tip 90 includes an EBC 92, which may include an abradable or abrasive layer, and an underlying CMC substrate 94. As shown in FIG. 9, the edges 96 of the EBC 92 and CMC substrate 94 may have a curved shape and form a protrusion 98 having a curved or rounded ridge.

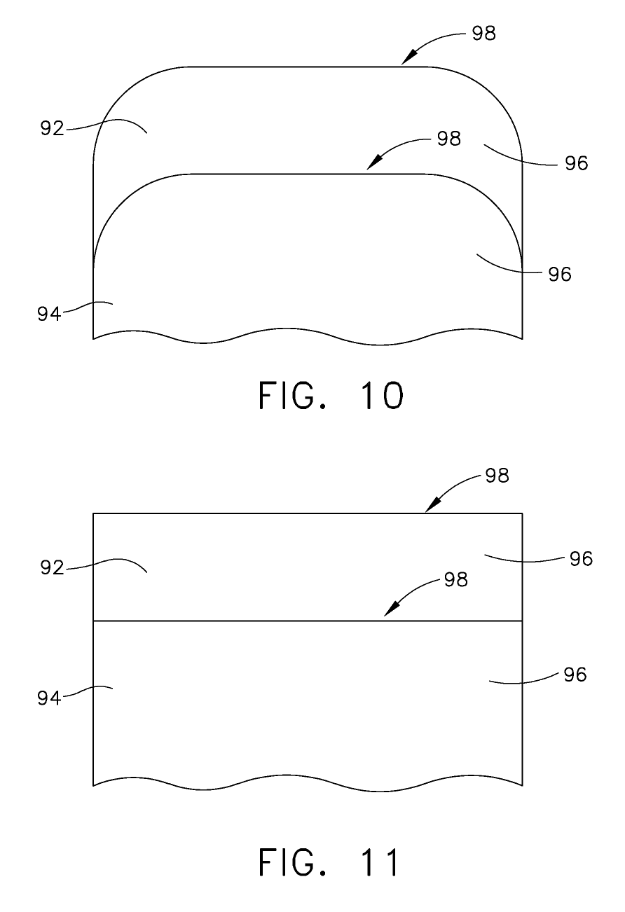

FIGS. 10 and 11 are cross-sectional views of blade tips having protruding tips according to various embodiments of the invention. As shown in FIG. 8, the edges 96 of the EBC 92 and CMC substrate 94 may have a curved shape and form a protrusion 98 with a flat top. In another embodiment of the invention as shown in FIG. 11, the edges 96 of the EBC 92 and CMC substrate 94 may have a straight shape and form a protrusion 98 with a flat top.

EBCs and the CMC substrates may have similar cross-sectional profiles as shown in FIGS. 2-11, or they may have different cross-sectional profiles. For example, EBCs may have the edges that have a curved shape and form a recess with a flat base and curved or rounded edges, while the CMC substrates may have the edges having a curved shape and a curved or rounded recess.

According to an embodiment of the invention, the blade tip may be coated with EBC having a patterned abradable or abrasive layer. For example, the patterns may include, but are not limited to ridges that may be shaped ridges to follow the shroud flowpath, such as flat ridges, rounded ridges, single point or multi-point tips.

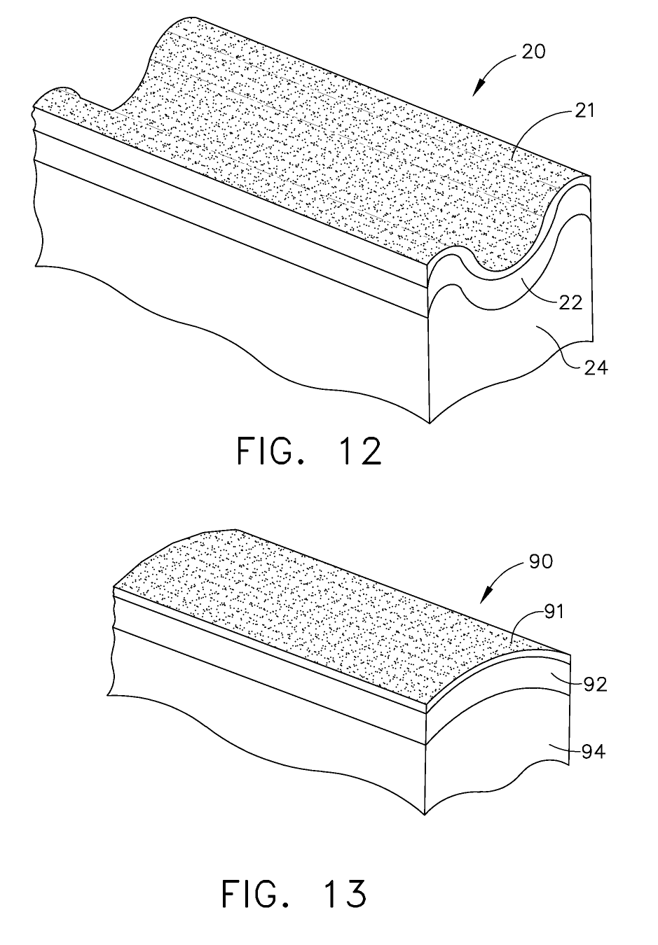

FIG. 12 is a perspective view of a blade tip 20 having a recessed configuration and a patterned abradable or abrasive layer 21 according to an embodiment of the invention. For example, the patterned abradable or abrasive layer 21 may be the top layer of the EBC 22. FIG. 13 is a perspective view of a blade tip 90 having a protruding configuration and a patterned abradable or abrasive layer 91 according to an embodiment of the invention. For example, the patterned abradable or abrasive layer 91 may be the top layer of the EBC 92.

To form the recessed or protruding CMC tip, core airfoil structural SiC plies may be extended through the tip of the airfoil that may be defined via non-conventional machining methods, such as ultrasonic machining, or preformed during the CMC molding process.

Certain tip configurations may provide manufacturing advantages over other configurations. For example, the recessed tip configuration shown in FIG. 2 with edges 26 of the EBC 22 and CMC substrate 24 having a curved shape and form a curved or rounded recess 28 may be simpler to manufacture than configurations that have straight edges 22, such as the recesses of FIG. 7 or 8. In addition, certain configurations provide mechanical advantages. For example, the protruding tip configuration shown in FIG. 9 may allow for good coating adhesion of the EBC 92 to the CMC substrate 94.

As discussed above, according to embodiments of the invention, the blade may be made of a CMC and include an EBC. The shroud surrounding the blade may be made of a CMC and include an EBC or it may be made of a metal and include a thermal barrier coating (TBC) or other similar ceramic coating.

Various types of CMC materials may be used to form the blade or shroud of the invention. For example, CMC materials having a silicon-containing matrix and reinforcing materials, including, but not limited to silicon carbide, silicon nitride, and mixtures thereof.

EBC coatings may be applied to CMCs to protect them from the harsh environment of high temperature engine sections and improve recession resistance. EBCs can provide a dense, hermetic seal against the corrosive gases in the hot combustion environment, which can rapidly oxidize silicon-containing CMCs and monolithic ceramics. Additionally, silicon oxide is not stable in high temperature steam, but is converted to volatile (gaseous) silicon hydroxide species. Thus, EBCs can help prevent dimensional changes in the ceramic component due to such oxidation and volatilization processes.

According to an embodiment of the invention, the environmental barrier coating materials may include those typically used for silicon-based, high temperature substrates such as silicon carbide, silicon nitride, and composites, thereof These materials have a coefficient of thermal expansion that is a match or near-match to the substrate. Typically, multiple layers are needed for the successful adhesion of EBC materials to the substrate including a bond coat and at least one refractory oxide layer. The bond coat may include materials such as elemental silicon, silicon alloys, and metal suicides that getter oxygen without the evolution of gaseous byproducts. Typical EBC refractory oxide layers described in the art including barium strontium aluminosilicate (BSAS), mullite, rare earth disilicates (e.g. ytterbium disilicate), rare earth monosilicates (e.g. yttrium monosilicate), and mixtures thereof, would be the best choices to comprise one or more layers of a robust blade tip that would remain adhered to the substrate for long times. However, any other metal oxide, metal carbide, metal boride, or metal nitride with a coefficient of thermal expansion that matches or nearly matches the coefficient of thermal expansion of the substrate material may be used. The selection of the EBC materials may be varied depending on the design of the robust blade tip.

In various embodiments of the invention, the EBC for the blade tip, shroud, or both the blade tip and shroud may include an abradable or abrasive layer to reduce blade tip wear during tip rub events. According to an embodiment of the invention, the abradable or abrasive layer may be the top layer of the EBC.

An abradable layer abrades when it is rubbed against a harder, denser, or heavier surface. In particular, the abradable layer may provide a compliant, less stiff material that will yield or fracture and impart less force to the remaining blade structure during a rub. Any worn or fractured abradable material will be replaced by underlying EBC coating and CMC substrate to prevent further leakage or tip recession. By contrast, an abrasive layer may include a harder, denser, or heavier EBC material that causes wear of an abradable layer. An abrasive layer may provide a stiffer material that the shroud material yields to, thereby reducing the amount of wear on the blade tip.

According to an embodiment of the invention, a blade tip may include an EBC with an abradable layer. The shroud may include an EBC or metal coating with an abrasive layer that is harder, denser, or heavier than the abradable layer of the blade tip such that when the blade tip rubs against the shroud during engine operation, the abradable layer wears away from the blade tip, thereby preventing damage to the blade,

According to another embodiment of the invention, a shroud may include an EBC or metal coating with an abradable layer, The blade tip may include an EBC with an abrasive layer that is harder, denser, or heavier than the abradable layer of the blade tip such that when the blade tip rubs against the shroud during engine operation, the abradable layer wears away from the shroud, thereby preventing damage to the blade.

The EBC and its abradable or abrasive layer may be applied in a variety of geometries. For example, the EBC and abradable or abrasive layer may have fiat, curved, ridge, conical, localized moguls, and to improve their effectiveness in reducing tip rub forces.

The EBCs may be applied using standard, industrial coating processes including, but not limited to plasma spray and vapor deposition techniques such as chemical vapor deposition and electron beam physical vapor deposition, In addition, the EBC may be applied by laser additive processes where an EBC powder is laid on layer by layer similar to 3D printing. By this method, the EBC powder and/or the density of the abradable or abrasive layer may be varied.

This invention enables the use of CMCs for turbine blades, which allows higher turbine inlet temperature capabilities, which improves efficiency. CMC turbine blades also allow for a reduction in engine weight.

While the invention has been described with reference to a preferred embodiment, it will be understood by those skilled in the art that various changes may be made and equivalents may be substituted for elements thereof without departing from the scope of the invention, In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A robust turbine blade, comprising;
a ceramic matrix composite (CMC) turbine blade having a leading edge, a trailing edge, a blade tip and an opposed root end;
said ceramic turbine blade being curved in at least one dimension between said leading edge and said trailing edge;
said blade tip having one of a recessed tip and a protruding tip; and,
one of an abradable layer and an abrasive layer disposed on said blade tip and being at least one of recessed or protruding.

2. The robust turbine blade of claim 1, said blade tip being recessed and said one of an abradable layer and an abrasive layer being recessed.

3. The robust turbine blade of claim 2, said recessed blade tip defining a channel 28 disposed between raised edges.

4. The robust turbine blade of claim 3, said one of an abradable layer and an abrasive layer further comprising one of a straight base or a curved base, between said raised edges of said blade tip.

5. The robust turbine blade of claim 4, said one of an abradable layer and an abrasive layer further comprising one of curved raised edges or straight raised edges.

6. The robust turbine blade of claim 4, wherein said raised edges of said abradable layer reduce tip rub forces.

7. The robust turbine blade of claim 4, said recessed configuration of said blade tip and said one of an abradable layer and an abrasive layer forming a mechanical hold to retain said one of an abradable layer and an abrasive layer and prevent full liberation of said one of an abradable layer and an abrasive layer during a rub event.

8. The robust turbine blade of claim 1, said CMC turbine blade tip being a protruding layer and said one of an abradable layer and an abrasive layer.

9. The robust turbine blade of claim 8, said CMC turbine blade tip having a curved shape and said one of an abradable layer and an abrasive layer having a curved shape.

10. The robust turbine blade of claim 9, said blade tip and said one of an abradable layer and an abrasive layer each having at least one of a flat top and a curved top.

11. The robust turbine blade of claim 1, further comprising an environmental barrier coating disposed between said CMC blade tip and said one of an abradable layer and an abrasive layer.

12. The robust turbine blade of claim 1, said one of an abradable layer and an abrasive layer having a pattern.

13. The robust turbine blade of claim 12, said pattern being one of shaped ridges, flat ridges, rounded ridges, single point or multi-point tips, conicals and localized moguls.

14. A robust turbine blade, comprising:
a ceramic matric composite (CMC) turbine blade having a geometrically shaped blade tip to increase mechanical hold with one of an abrasive or an abradable layer;
said blade tip and said one of an abrasive layer and an abradable layer both being one of flat, protruding or recessed shaped.

15. The robust turbine balde of claim 14 wherien said one of an abrasive layer and an abradable layer are formed one of with an environmental coating or independently of said environmental coating.

16. The robust turbine blade of claim 14, said blade tip further comprising edges.

17. The robust turbine blade of claim 15, said at least one of an abrasive layer and an abradable layer having edges.

18. The robust turbine blade of claim 16, said edges being one of curved or flat.

19. robust turbine blade of claim 17 wherein said blade tip and said one of an abrasive or abradable layer are recessed with one or curved or sharp corners.

20. The robust turbine blade, comprising:
a ceramic matrix composite (CMC) turbine blade having a leading edge, a trailing edge a blade tip and an opposed root end;
said CMC turbine blade defining an airfoil shape;
said blade tip being substantially flat;
one of an abradable layer and an abrasive layer disposed on said blade tip, said one of an abradable layer and an abrasive layer being substantially flat.

21. The robust turbine blade of claim 20, further comprising an environmental barrier coating disposed between said CMC blade tip and said one of an abradable layer and an abrasive layer.
